(19) United States
(12) Patent Application Publication
(10) Pub. No.: US 2015/0081878 A1
(43) Pub. Date: Mar. 19, 2015

(54) DESCRIBING DATACENTER RACK INFORMATION IN MANAGEMENT SYSTEM

(71) Applicant: AMERICAN MEGATRENDS, INC., NORCROSS, GA (US)

(72) Inventors: Chittaraiah Pabba, Cumming, GA (US); Joseprabu Inbaraj, Suwanee, GA (US)

(73) Assignee: AMERICAN MEGATRENDS, INC., NORCROSS, GA (US)

(21) Appl. No.: 14/031,228

(22) Filed: Sep. 19, 2013

(51) Int. Cl. H04L 12/24

(52) U.S. Cl. CPC H04L 41/00
USPC 709/224

(57) ABSTRACT

Present disclosure relates to a rack management system for automatically construct a rack, configure, monitor and manage managed devices on rack. Rack management system includes: (a) user interface module, (b) database, (c) rack management communication interface, (d) rack management module, (e) device discovery module, and (f) file loader. User interface module is used to allow an administrator to enter or import rack management information of managed devices. Database is used to store the rack management information. Rack management communication interface is implemented to facilitate the communication between the rack management system and managed devices. Rack management module is used to construct, configure, monitor, and manage the managed devices. Device discovery module discovers all managed devices according to the information entered by the administrator through the user interface module. File loader is used to load rack management information to the database, device discovery module and rack management module.

### FIELD

The present disclosure generally relates to computer server rack management, and more particularly to describing datacenter rack information in XML format for use in a rack management system.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

With the proliferation of computer data centers, and computer servers, the need has developed for more powerful tools to manage these computer servers, storage and network devices, also referred as managed devices, installed on one or more racks in computer data centers as they have increased in size and complexity. Simple network management protocol (SNMP) is one of tools available for managing such computer servers, storage and network devices. The SNMP includes two primary elements: a manager and agents. The SNMP manager is the console through which a network administrator performs rack management functions. The SNMP agents are entities that interface to the actual managed devices. Computer servers, storage and network devices, and Power Distribution Units (PDU) with network manageability are examples of managed devices that contain manageable objects. The manageable objects of each managed device might be hardware, configuration parameters, performance statistics, and so on, that directly relate to the current operation of the managed devices. The managed objects are arranged in a management information base (MIB) and each manageable object is referred to as an object in the MIB. The SNMP allows managers and agents to communicate for the purpose of accessing these MIB objects.

Typically, the MIB is organized in a tree structure composed of branch nodes and leaf nodes. The MIB objects representing the managed objects of the same network device usually reside at the leaf nodes rooting from the same branch node. Each MIB object has an object identifier (OID), which is a sequence of integers in a tree structure that uniquely identifies the MIB object residing at a leaf node. Detailed definition of these OIDs are defined and discussed in Internet documentations such as RFC 1155, “Structure and Identification of Management Information for TCP/IP based internets”, RFC 1213, “Management Information Base for Network Management of TCP/IP-based internets”, and RFC 1157, “A Simple Network Management Protocol”, which are incorporated herein by reference.

When the manager requests a value of an MIB object from an agent, the OID of the MIB object should be sent by the manager and traversed by the agent.

Though the SNMP access is simple due to the small number of command messages, it requires that the user have in-depth knowledge of the MIB, and particularly be familiar with the OID of each MIB object. Also, building the variable binding which includes the OID and the corresponding object value is typically a tedious task and is subject to human errors. Additionally, the computer servers, storage and network devices to be managed by the rack management system are vastly different. They include power distribution units, computers, disk arrays, routers, network switches, and powerful computer servers. Since these devices may come from different vendors, they have significant differences and these differences make the monitoring and managing these devices a difficult task. Constructing and maintaining these racks require the user enter large amount of management information individually for each managed device from every manufacturer. Entering the MIB information can be very tedious, and error-prone. Many legacy datacenters still maintain their rack and server information in Excel format. Therefore, it will be advantageous to have a system that allows an administrator to input, import, save, edit and export management information associated with the specific managed device, and to map functionalities of such devices with MIB OID's to facilitate the monitoring and management of these devices.

Therefore, heretofore unaddressed needs still exist in the art to address the aforementioned deficiencies and inadequacies.

### SUMMARY

In one aspect, the present disclosure relates to a rack management system for automatically construct a rack, configure, monitor and manage managed devices installed on the rack. In certain embodiments, the rack management system includes: (a) a user interface module, (b) a database, (c) a rack management communication interface, (d) a rack management module, (e) a device discovery module, and (f) a file loader. In certain embodiments, the user interface module is used to allow an administrator to enter or import rack management information of the managed devices on the rack. In certain embodiments, the database is used to store the rack management information of the managed devices on the rack. In certain embodiments, the rack management communication interface is implemented to facilitate the communication between the rack management system and the managed devices on the rack through a communication link. In certain embodiments, the rack management module is used to construct, configure, monitor, and manage the managed devices. In certain embodiments, the device discovery module discovers all managed devices according to the information entered by the administrator through the user interface module. In certain embodiments, the file loader can be used to load the rack management information of the managed devices on the rack to the database, the device discovery module and the rack management module.

In certain embodiments, the managed devices on the rack include one or more of following devices: power distribution units (PDU), computer servers, storage devices, access servers, switches, bridges, hubs, IP telephones, IP video cameras, computer hosts, network devices and printers. In certain embodiments, the rack management information includes the management information of each of the managed devices on the rack. The management information of each of the managed devices on the rack includes name of the manufacturer, model number, IP address, Device name, management information base (MIB) file, and a standard set of management functions described in an INI file. In certain embodiments, the rack management information of the managed devices on the rack is entered manually through the user interface module. In certain embodiments, the rack management information of the managed devices on the rack is automatically imported from a set of pre-edited files The set of pre-edited files includes the rack management information exported from a rack that contains similar managed devices and similar configuration as the managed devices on the rack.

In certain embodiments, the set of pre-edited files includes at least a management information base (MIB) file containing all management functions and its related object identification (OID), an INI file containing a standard set of management functions of the rack management system, and a rack definition file containing rack configuration information using a rack definition language. The rack management module parses the MIB file, maps the standard set of rack management functions of the managed devices on the rack, and obtains the object identification (OID) associated with the standard set of management functions of the managed devices on the rack. In certain embodiments, the rack definition file can be a text file, an excel file, or an XML file. The standard set of management functions of the rack management system in the INI file contains a subset of the management functions available to the managed device from its manufacturer.

In certain embodiments, the device discovery module is designed to perform one or more of following functions: (a) loading the rack management information of the managed devices on the rack through the file loader from the database, (b) discovering the managed devices on the rack through the rack management communication interface and the communication link based on the rack management information of the managed devices on the rack including their IP addresses, and (c) creating one entry in the database for each discovered managed device for individual management of the discovered managed device. In certain embodiments, the rack management module uses simple network management protocol (SNMP) to monitor and manage the managed devices on the rack. In one embodiment, the rack management module further includes a web interface to allow the administrator to perform management functions remotely through internet, LAN, WAN, and Wi-Fi networks. In another embodiment, the rack management module further includes a command line interface (CLI) to allow the administrator to perform management functions locally through a RS-232 network.

In another aspect, the present disclosure relates to a method for a rack management system to construct a rack, configure, monitor and manage managed devices on the rack. The method includes one or more of following functions: (a) entering rack management information of the managed devices on the rack by an administrator using a user interface module of the rack management system, or importing a set of pre-edited files exported from a rack that has similar managed devices and configuration, (b) storing the rack management information of the managed devices on the rack into a database of the rack management system using a file loader of the rack management system, (c) loading rack management information of the managed devices on the rack through the file loader to a device discovery module, (d) discovering the managed devices on the rack one by one based on the rack management information of the managed devices on the rack, (e) creating one entry in the database for each discovered managed device for rack management, (f) exporting rack management information of the managed devices on the rack, (g) updating the managed device status and OID of the discovered managed device in the database individually, (h) loading the OID information and a set of pre-determined rack management functions through the file loader to the rack management module, and (i) monitoring and managing the managed devices on the rack through the rack management module.

In certain embodiments, the set of pre-edited files includes at least a management information base (MIB) file containing all management functions and its related object identification (OID), an INI file containing a standard set of management functions of the rack management system, and a rack definition file containing rack configuration information using a rack definition language. The rack management module parses the MIB file, maps the standard set of rack management functions of the managed devices on the rack, and obtains the object identification (OID) associated with the standard set of management functions of the managed devices on the rack. In one embodiment, the parsing of the MIB file and mapping of the standard management functions are carried out manually by using a user interface module. In another embodiments, the parsing of the MIB file and mapping of the standard management functions are carried out automatically by using the user interface module. In certain embodiments, the rack definition file can be one or more of a text file, an excel file, and an XML file.

In certain embodiments, the standard set of management functions of the rack management system in the INI file contains a subset of the management functions available to the managed device from its manufacturer. The rack management system further includes a rack management communication interface. In certain embodiments, the rack management communication interface is used for the rack management system to communicate with the managed devices on the rack through a communication link. In certain embodiments, the rack management module uses simple network management protocol (SNMP) to monitor and manage the managed devices on the rack. In one embodiment, the rack management module further includes a web interface to allow the administrator to perform management functions remotely through internet, LAN, WAN, and Wi-Fi networks. In another embodiments, the rack management module further includes a command line interface (CLI) to allow the administrator to perform management functions locally through a RS-232 network.

In yet another aspect, the present disclosure relates to a method for a rack management system to construct a number of target racks based on rack management information of a model rack. In certain embodiments, the method includes one or more of following operations: (a) importing rack management information from the model rack, (b) storing the imported rack management information of the model rack in a rack definition language (RDL) file, (c) exporting the rack management information of the model rack in the RDL file to rack management information of a target rack, (d) storing the rack management information of the target rack into a database of the rack management system, (e) discovering managed devices on the target rack using a device discovery module of the rack management system, (f) updating the status of the managed devices on the target rack, and (g) exporting updated rack management information of the target rack if necessary.

In certain embodiments, the rack management system includes RackInfo of the rack, NodeInfo of the rack, MIB files and INI files of all managed devices on the rack, and all related OIDs of objects on the rack. In certain embodiments, the rack management system includes a user interface module configured to allow an administrator to enter or import rack management information of the managed devices on the rack. In one embodiment, the rack management information is entered manually through the user interface module. In another embodiment, the rack management information is automatically imported from a set of pre-edited files. The set of pre-edited files contains the rack management information exported from the model rack that contains similar managed devices and similar configuration as the managed devices on the rack. In certain embodiments, the set of pre-edited files includes one or more of a text file, an excel file, and an XML file.

### BRIEF DESCRIPTION OF THE DRAWINGS

The accompanying drawings illustrate one or more embodiments of the disclosure and, together with the written description, serve to explain the principles of the disclosure. Wherever possible, the same reference numbers are used throughout the drawings to refer to the same or like elements of an embodiment, and wherein:

FIG. 1 schematically shows a block diagram of a rack management system for constructing, configuring, monitoring and managing the managed devices on a rack according to one embodiment of the present disclosure;

FIG. 2 shows an exemplary INI file of a PDU according to one embodiment of the present disclosure;

FIG. 3 shows a block diagram of a manager/agent model of an SNMP network according to one embodiment of the present disclosure;

FIG. 4 shows an exemplary user interface screen for automatically building a rack according to one embodiment of the present disclosure;

FIG. 5 shows an exemplary user interface screen for provide dynamic PDU support according to one embodiment of the present disclosure;

FIG. 6 shows a flow chart of operation of the rack management system for constructing, configuring, monitoring and managing the managed devices on the rack according to one embodiment of the present disclosure;

FIG. 7 shows an exemplary importing rack management information from a model rack and exporting imported rack management information to a group of racks having similar managed devices and configuration according to one embodiment of the present disclosure; and

FIG. 8 shows a flow chart of operation of the rack management system for importing rack management information from a model rack and exporting imported rack management information to a group of racks having similar managed devices and configuration according to one embodiment of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximates, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

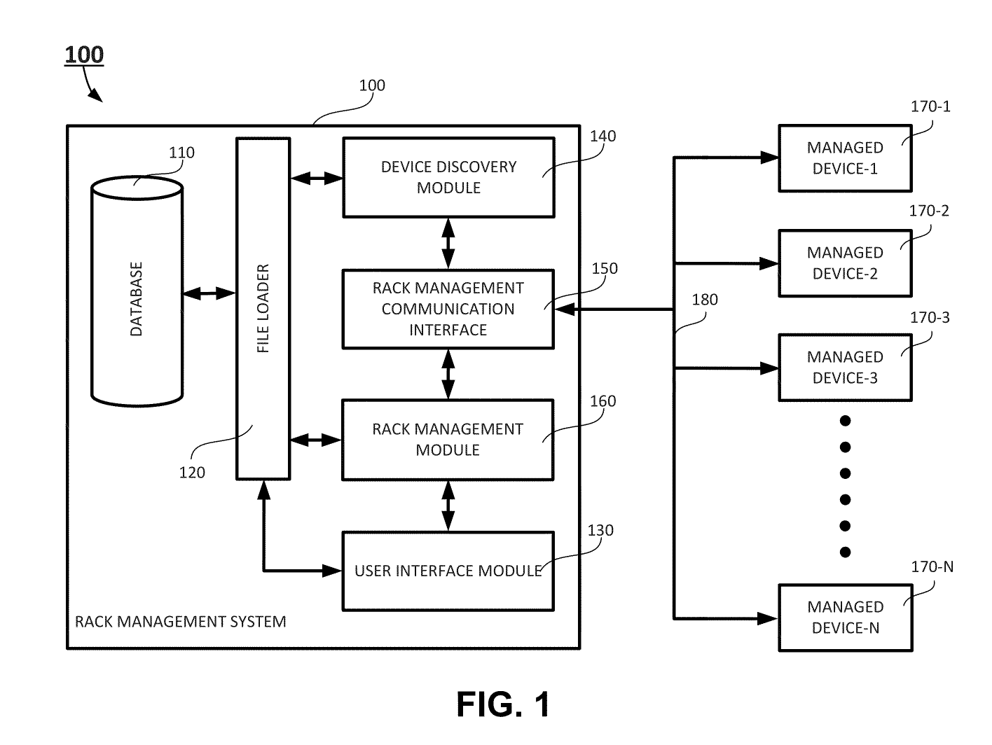

The present disclosure will now be described more fully hereinafter with reference to the accompanying drawings, FIGS. 1-7, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

In computer server centers or data centers, a large amount of computers, servers, routers, disk arrays, and switches are mounted on one or more racks and powered by power distribution units (PDUs). Monitoring and managing the operations of these managed devices on the rack are critically important. The managed devices on the rack can be any type of device, including, but not limited to, routers, access servers, switches, bridges, hubs, IP telephones, IP video cameras, computer hosts, and printers. A power distribution unit (PDU) is a device fitted with multiple outputs designed to distribute electric power, especially to racks of computers and networking equipment located within the computer server centers or data centers. Most computer servers, storage and network devices provide remote access. Common methods are accessible through SNMP and include a RS-232 serial connection (for local management) using a command-line interface (CLI) or a LAN network-controller (for remote management) using a web page. This allows an administrator to monitor and manage the managed devices on the rack from a remote terminal and interface with it to turn outlets or devices on or off, to schedule power shutdowns, to control load, etc. This can be helpful if a remote machine has gone into an unresponsive state and will not restart through normal means. The administrator can connect to the PDU where the computer servers, storage and network devices are plugged into to power-cycle these managed devices on the rack.

Referring now to FIG. 1, a block diagram of a rack management system 100 is schematically shown for constructing, configuring, managing and monitoring managed devices on a rack 170-I, I=1, 2, . . . , N, according to one embodiment of the present disclosure. The rack management system 100 includes a database 110, a file loader 120, a user interface module 130, a device discovery module 140, a rack management communication interface 150, a rack management module 160, managed devices on the rack 170-I, I=1, 2, . . . , N, and a communication link 180 configured to provide communication channel between the rack management communication interface 150 of the rack management system 100, and the managed devices on the rack 170-I.

In certain embodiments, the rack management system 100 includes one or more operating systems as well as one or more application programs. The operating system comprises a set of programs that control operations of the managed RS-232 or LAN/WAN devices using TCP/IP protocol. The application programs also provide a graphical user interface to the administrator. An application program is software that runs on top of the operating system software and uses computer resources made available through the operating system to perform application specific tasks desired by the user. The operating system is operable to multitask, i.e., execute computing tasks in multiple threads, and thus may be any of the following: MICROSOFT CORPORATION's “WINDOWS 95,” “WINDOWS CE,” “WINDOWS 98,” “WINDOWS 2000” or “WINDOWS NT”, “WINDOWS Vista,”, “WINDOWS 7,” and “WINDOWS 8,” operating systems, IBM's OS/2 WARP, APPLE's MACINTOSH OSX operating system, LINUX, UNIX, etc.

In certain embodiments, the rack management system 100 may include a web browser for remote access through the internet (not shown in FIG. 1), such as the INTERNET EXPLORER web browser from MICROSOFT CORPORATION of Redmond, Wash., that enables a remote management computer (not shown in FIG. 1) communicate over the Internet, local area network (LAN), wide area network (WAN) 104 with the rack management system 100.

In certain embodiments, the rack management system 100 may include a RS-232 connection (not shown in FIG. 1), such that the administrator can use a command line interface that enables a local management computer (not shown in FIG. 1) to communicate over the RS-232 connection with the rack management system 100.

In embodiment, the database 110 stores the rack management information of all supported managed devices on the rack, computer servers, storage and network devices, and PDUs including the name of the manufacture, the model number, an INI file and a management information base (MIB) file of the managed devices on the rack. The INI file contains the functionalities of the managed devices on the rack, including the function names and respective object identification (OID) for the functions. The functions contained in the INI file usually is a subset of all the functions the managed device can perform. The MIB file is a standard SNMP supported file format and it contains the OID values.

At a data center, one or more computer servers, storages and network devices (collectively called nodes) are installed a rack and each computer server, storage and network device requires a PDU unit. The database 110 contains (a) information about a server/device: NodeInfo, and (b) information about a rack: RackInfo. In certain embodiments, the RackInfo includes: rack name, power limit, and type of power management information. The NodeInfo includes: node name, node IP address, rated power, power zone, inlet temperature etc. For example: following is an exemplary information for two nodes in a rack:

| | |
|---|---|
| Rack Name: | HostRack |
| Rated Power: | 1000 W |
| Type of PM: | HOST |

| Node Name: | PDU-1 |
|---|---|
| Server IP: | 10.10.1.1 |
| Rated Power: | 200 W |
| Power Zone: | Critical |
| Inlet Temp: | 22 |

| Node Name: | Web-server1 |
|---|---|
| Server IP: | 10.10.1.2 |
| Rated Power: | 200 W |
| Power Zone: | Critical |
| Inlet Temp: | 22 |

In certain embodiments, the rack management information such as NodeInfo and RackInfo can also be imported, saved, exported, edited in text files, Microsoft Excel files, or other file formats, and a proprietary rack definition language (RDL) can also be used for these formats. Because of the various tags used in XML file, the readability and editability of XML files are improved comparing to the text files, and Microsoft Excel files. In certain embodiments, the RDL uses XML file format including many different tags to allow the rack management system to identify the key rack management functions or parameter necessary for the rack management. Following is a highlight of the RDL:
The comments are introduced in between “<?” and “?>”;
This example is an XML file and uses the XML version 1.0, and UTF-8 encoding;
Multiple racklist can be placed between the tags <racklist> and </racklist>;
Each rack is placed between the tags <rack> and </rack>;
The rack name, powerlimit, and type are located within the <rack> tag, as shown in the example, the rack name is HostRack, the rack powerlimit is 1000 watts, and it's a Host rack, one of the two types of rack: Host rack and BMC rack;
Multiple nodes can be placed between the tags <node> and </node> with corresponding names in between the <name> and </name> tags, as shown in the example, Web-server1, Web-server2 are the nodes (managed devices) installed in the HostRack;
The IP address of the node is placed in between <ipaddress> and </ipaddress> tags;
The ratedpower of the node is placed in between <ratedpower> and </ratedpower> tags;
The powerzone of the node is placed in between <powerzone> and </powerzone> tags;
The inlettemp of the node is placed in between <powerzone> and </powerzone> tags;
Many other tags may be added between the <node> and </node> tags as part of the attribute of the node; and
Many nodes can be inserted between the <rack> and </rack> tags as the rack increases the number of managed devices on the rack.

Following is an exemplary RDL file for two managed devices on the rack:

<?xml version=“1.0” encoding=“UTF-8”?>
<racklist>
<rack name= “HostRack” powerlimit=“1000” type=“Host”>

<node>

<name>PDU-1</name >
<ipaddress>10.10.1.1</ipaddress>
<ratedpower>200</ratedpower>
<powerzone>Critical</powerzone >
<inlettemp>22</inlettemp>

</node>
<node>

<name>Web-server1</name>
<ipaddress>10.10.1.2</ipaddress>
<ratedpower>200</ratedpower>
<powerzone>Critical</powerzone>
<inlettemp>22</inlettemp>

</node>

</rack>
</racklist>

In one embodiment, the database 110 stores information regarding all supported managed devices on the rack including the name of the manufacturer, the model number, the INI file, and the MIB file of all supported managed devices on the rack. The INI file contains supported functionalities of the managed devices on the rack including the function names and respective object identifications (OIDs) for these functions. The MIB file is a standard SNMP supported file format and it contains the corresponding OID values.

In embodiment, the file loader 120 interacts with the database 110 and stores information to and retrieves information from the database 110. The file loader 120 performs following functions:
store and retrieve NodeInfo;
store and retrieve RackInfo;
store and retrieve MIB and INI files; and
store and retrieve related object identifier (OID).

The file loader 120 interacts with the device discovery module 140 to discover all managed devices on the rack 170-I, I=1, 2, . . . , N that are networked through the network channel 180, and retrieves rack and node information from each and every one of the nodes and store the rack and node information into the database 110.

The file loader 120 interacts with the rack management module 160 to update rack and node information of the managed devices on the rack 170-I, I=1, 2, . . . , N, and stores and updates rack and node information in the database 110.

The file loader 120 interacts with the user interface module 130 to retrieve rack and node information, the MIB information, and OID information from external files, such as XML files, Excel Files, and text files etc. The rack information, the node information, the MIB and the OID information are then stored in the database 110.

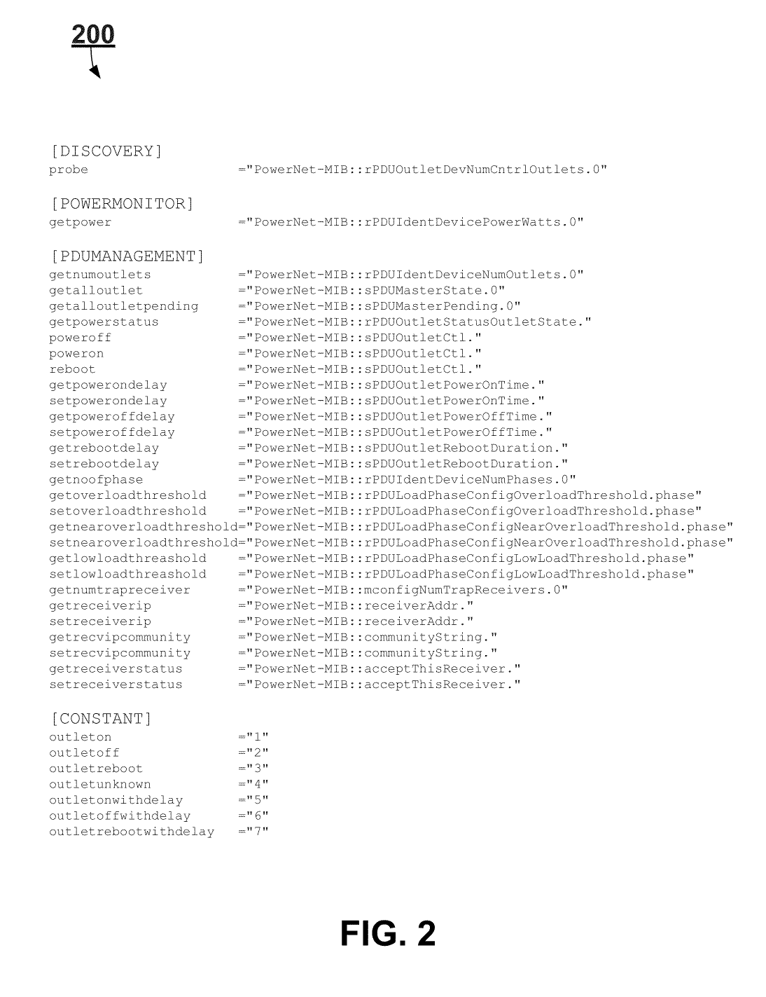

In certain embodiments, the user interface module 130 allows the administrator to enter or import the rack management information of the managed devices on the rack such as the PDU of the rack, or the computer servers, storage and network devices installed on the rack. The rack management information can be entered either manually line by line through a series of parameters editing screens, or by automatic method through reading a number of files (importing). The files include text files, XML files, Excel files, or a proprietary rack definition language (RDL) file. Once the rack management information of the managed devices on the rack is entered, the rack management information is stored into the database 110 by using the file loader 120. Once The rack management information of the managed devices on the rack is entered, the rack management information is transmitted to the rack management module 160 for processing. The rack management module 160 maps the MIB information into a subset of basic management functions for the managed devices on the rack, obtains the corresponding OID of each management function, and saves the subset of basic management functions for the managed devices on the rack and their corresponding OIDs into the database 110 by using the file loader 120. FIG. 2 shows an exemplary INI file (apc.ini) of a PDU manufactured by American Power Conversion (APC) according to one embodiment of the present disclosure, and an exemplary subset of basic PDU management functions is listed under the entry of [PDUMANAGEMENT].

Referring now to FIG. 2, an exemplary INI file 200 of a PDU manufactured by American Power Conversion (APC) is shown according to one embodiment of present disclosure. In one embodiment, there are over 3000 objects, and over 3000 OIDs in a complete APC product MIB. In one embodiment, the INI file 200 includes only a small subset of the management functions available to the PDU from APC. In the following example, only 29 power management functions and 17 unique OIDs are included in the power management software. The INI file 200 includes only a small subset of the management functions available to the PDU from APC. It includes 4 sections:

1. Discovery

$$Probe = {}^{``} PowerNet \text{-} MIB :: rPDUOutletDevNumCntrlOutlets {.0}^{″} = 1.3 .6 .1 .4 .1 .318 .1 .1 .12 .3 .1 .3 ;$$

2. PowerMonitor

$$getpower = {}^{``} PowerNet \text{-} MIB :: rPDUIdentDevicePowerWatts {.0}^{″} = 1.3 .6 .1 .4 .1 .318 .1 .1 .12 .1 .16$$

3. PDUManagement

$$Getnumoutlets = {}^{``} PowerNet \text{-} MIB :: rPDUIdentDeviceNumOutlets {.0}^{″} = 1.3 .6 .1 .4 .1 .318 .1 .1 .12 .1 .16$$

$$getalloutlet = {}^{``} PowerNet \text{-} MIB :: sPDUMasterState {.0}^{″} = 1.3 .6 .1 .4 .1 .318 .1 .1 .4 .2 .2 ;$$

$$getalloutletpending = {}^{``} PowerNet \text{-} MIB :: sPDUMasterPending {.0}^{″} = 1.3 .6 .1 .4 .1 .318 .1 .1 .4 .2 .3 ;$$

$$getpowerstatus = {}^{``} PowerNet \text{-} MIB :: rPDUOutletStatusOutletState {.}^{″} = 1.3 .6 .1 .4 .1 .318 .1 .1 .12 .3 .5 .1 .1 .4$$

$$poweroff = {}^{``} PowerNet \text{-} MIB :: sPDUOutletCtl {.}^{″} = 1.3 .6 .1 .4 .1 .318 .1 .1 .4 .4 .2 .1 .3$$

$$poweron = {}^{``} PowerNet \text{-} MIB :: sPDUOutletCtl {.}^{″} = 1.3 .6 .1 .4 .1 .318 .1 .1 .4 .4 .2 .1 .3$$

$$reboot = {}^{``} PowerNet \text{-} MIB :: sPDUOutletCtl {.}^{″} = 1.3 .6 .1 .4 .1 .318 .1 .1 .4 .4 .2 .1 .3$$

$$getpowerondelay = {}^{``} PowerNet \text{-} MIB :: sPDUOutletPowerOnTime {.}^{″} = 1.3 .6 .1 .4 .1 .318 .1 .1 .4 .5 .2 .1 .2$$

$$setpowerondelay = {}^{``} PowerNet \text{-} MIB :: sPDUOutletPowerOnTime {.}^{″} = 1.3 .6 .1 .4 .1 .318 .1 .1 .4 .5 .2 .1 .2$$

$$getpoweroffdelay = {}^{``} PowerNet \text{-} MIB :: sPDUOutletPowerOffTime {.}^{″} = 1.3 .6 .1 .4 .1 .318 .1 .1 .4 .5 .2 .1 .4$$

$$setpoweroffdelay = {}^{``} PowerNet \text{-} MIB :: sPDUOutletPowerOffTime {.}^{″} = 1.3 .6 .1 .4 .1 .318 .1 .1 .4 .5 .2 .1 .4$$

$$getrebootdelay = {}^{``} PowerNet \text{-} MIB :: sPDUOutletRebootDuration {.}^{″} = 1.3 .6 .1 .4 .1 .318 .1 .1 .4 .5 .2 .1 .5$$

$$setrebootdelay = {}^{``} PowerNet \text{-} MIB :: sPDUOutletRebootDuration {.}^{″} = 1.3 .6 .1 .4 .1 .318 .1 .1 .4 .5 .2 .1 .5$$

$$getnoofphase = {}^{``} PowerNet \text{-} MIB :: sPDUIdentDeviceNumPhases {.0}^{″} = 1.3 .6 .1 .4 .1 .318 .1 .1 .12 .1 .9$$

$$getoverloadthreshold = {}^{``} PowerNet \text{-} MIB :: rPDULoadPhaseConfigOverloadThreshold . {phase}^{″} = 1.3 .6 .1 .4 .1 .318 .1 .1 .12 .2 .2 .1 .1 .4$$

$$setoverloadthreshold = {}^{``} PowerNet \text{-} MIB :: rPDULoadPhaseConfigOverloadThreshold . {phase}^{″} = 1.3 .6 .1 .4 .1 .318 .1 .1 .12 .2 .2 .1 .1 .4$$

$$getnearoverloadthreshold = {}^{``} PowerNet \text{-} MIB :: rPDULoadPhaseConfigNearOverloadThreshold . {phase}^{″} = 1.3 .6 .1 .4 .1 .318 .1 .1 .12 .2 .2 .1 .1 .3$$

$$getnearoverloadthreshold = {}^{``} PowerNet \text{-} MIB :: rPDULoadPhaseConfigNearOverloadThreshold . {phase}^{″} = 1.3 .6 .1 .4 .1 .318 .1 .1 .12 .2 .2 .1 .1 .3$$

$$getlowloadthreashold = {}^{``} PowerNet \text{-} MIB :: rPDULoadPhaseConfigLowLoadThreshold . {phase}^{″} = 1.3 .6 .1 .4 .1 .318 .1 .1 .12 .2 .2 .1 .1 .2$$

$$setlowloadthreashold = {}^{``} PowerNet \text{-} MIB :: rPDULoadPhaseConfigLowLoadThreshold . {phase}^{″} = 1.3 .6 .1 .4 .1 .318 .1 .1 .12 .2 .2 .1 .1 .2$$

$$getnumtrapreceiver = {}^{``} PowerNet \text{-} MIB :: mconfigNumTrapReceivers {.0}^{″} = 1.3 .6 .1 .4 .1 .318 .2 .1 .1$$

$$getreceiverip = {}^{``} PowerNet \text{-} MIB :: receiverAddr {.}^{″} = 1.3 .6 .1 .4 .1 .318 .2 .1 .2 .1 .2$$

$$setreceiverip = {}^{``} PowerNet \text{-} MIB :: receiverAddr {.}^{″} = 1.3 .6 .1 .4 .1 .318 .2 .1 .2 .1 .2$$

$$getrecvipcommunity = {}^{``} PowerNet \text{-} MIB :: communityString {.}^{″} = 1.3 .6 .1 .4 .1 .318 .2 .1 .2 .1 .3$$

$$setrecvipcommunity = {}^{``} PowerNet \text{-} MIB :: communityString {.}^{″} = 1.3 .6 .1 .4 .1 .318 .2 .1 .2 .1 .3$$

$$getreceiverstatus = {}^{``} PowerNet \text{-} MIB :: acceptThisReceiver {.}^{″} = 1.3 .6 .1 .4 .1 .318 .2 .1 .2 .1 .5$$

$$setreceiverstatus = {}^{``} PowerNet \text{-} MIB :: acceptThisReceiver {.}^{″} = 1.3 .6 .1 .4 .1 .318 .2 .1 .2 .1 .5$$

4. Constants
outleton=“1”
outletoff=“2”
outletreboot=“3”
outletunknown=“4”
outletonwithdelay=“5”
outletoffwithdelay=“6”
outletrebootwithdelay=“7”

The user interface 130 facilitates the administrator with options for configuring an application for various features according to the user needs and identifies the attributes of the product to meet the requirements of an end user. This helps the user to manage a device easily and effectively. Various feature configurations are as follows:
setting global user account, add, edit, delete and save user accounts
authenticate users;
configuring device (node) discovery range
adding single device
adding a rack
adding a PDU to the rack;
adding a managed device to the rack
adding host server to PDU
adding Host server to Host rack
edit single managed device, rack, PDU, Host server, and Host rack
automating rack builder
authenticating discovered devices
configuring monitoring settings
configuring power zone settings
performing remote control actions
retrieving and reviewing event logs
generating and reviewing report information about host rack, BMC rack, inlet temperature monitor
configuring email alerts
retrieving SNMP Trap log information
managing using scripts
generating XMS reports based on the information stored in the database

In certain embodiments, the device discovery module 140 receives the rack management information of the managed devices on the rack such as the MIB files and INI files through the file loader 120, and based on a pre-determined IP address range, the rack management system 100 discovers connected and managed devices on the rack such as the managed devices on the rack 170-I, I=1, 2, . . . , N through the rack management communication interface 150 and the communication link 180. Once the managed devices on the rack 170-I are discovered, the managed devices on the rack 170-I and a basic set of PDU management functions are mapped, and their corresponding OIDs are all stored back to the database 110, through the file loader 120. The rack management system 100 is ready to perform monitoring and managing functions to the managed devices on the rack 170-I. The managed devices on the rack 170-I discovered are authenticated through the user interface 130.

The rack management communication interface 150 is configured to facilitate the communication between the rack management system 100 and the managed devices on the rack 170-I, using simple network management protocol (SNMP). The main communication channel between the rack management system 100 and the managed devices on the rack 170-I is the communication link 180. In one embodiment, the communication is carried out by using a RS-232 interface with a RS-232 connection. In another embodiment, the communication is carried out by using internet through LAN/WAN/Wi-Fi networks. Each of the managed devices on the rack 170-I has its unique IP address (node IP address).

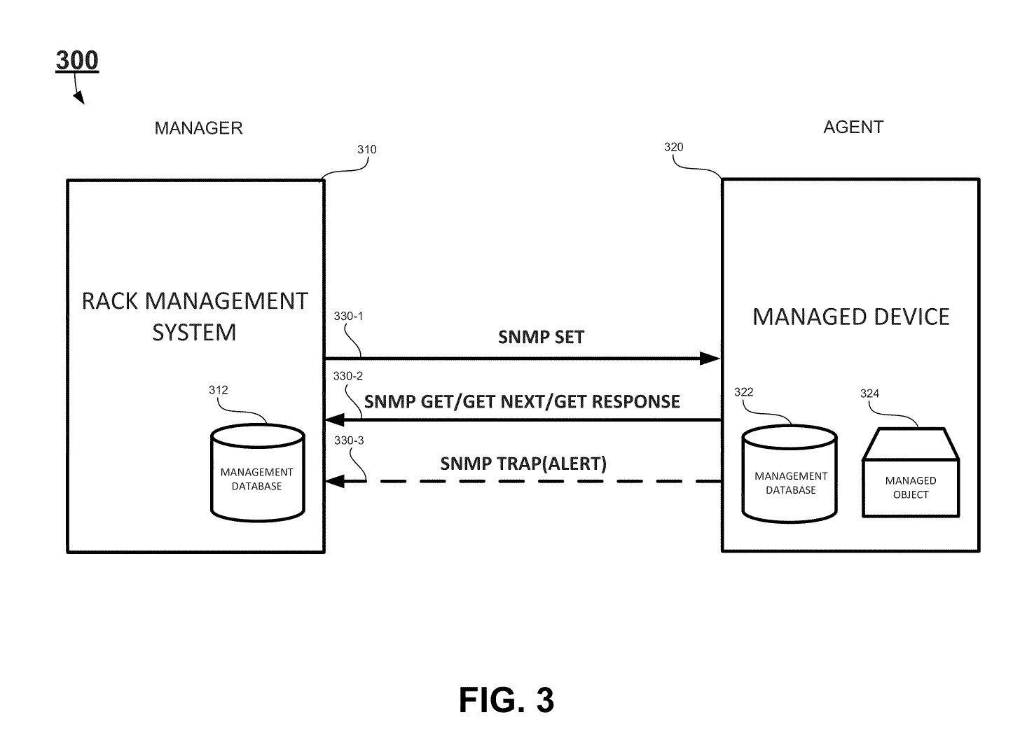

SNMP is based on the manager/agent model 300 as shown in FIG. 3. The model 300 includes a management system (manager) 310, a managed element (agent) 320, a management information base (MIB) 312 for the manager 310, a management information base (MIB) 322 for the agent 320, managed objects 324 and the network protocol 330. The manager 310 provides the interface between a human network manager and the manager 310. The agent 320 provides the interface between the manager and the physical device(s) being managed such as a server or a printer.

The manager and agent use a Management Information Base (MIB) and a relatively small set of commands to exchange information. In order to be able to manage a large amount of managed devices on the rack from various vendors, the MIB 312 for the manager 310 is usually a small subset of the MIB 322 for the agent. In the example shown in FIG. 2, only 29 power management functions and 17 unique OIDs are included in the MIB 312 for the manager 310 and used by a rack management software.

Typically, the MIB is organized in a tree structure composed of branch nodes and leaf nodes. The MIB objects representing the managed objects of the same network device usually reside at the leaf nodes rooting from the same branch node. Each MIB object has an object identifier (OID), which is a sequence of integers in a tree structure that uniquely identifies the MIB object residing at a leaf node. When the manager 310 requests a value of a MIB object from an agent 320, the OID of the MIB object should be sent by the manager 310 and traversed by the agent 320.

SNMP access is used to perform management function on a computer server rack, and a variable binding that contains an OID, a type and a corresponding object value, should be built. The variable bindings are the actual data that are transported back and forth inside SNMP messages. Typically, the SNMP uses five basic messages: GET, GET-NEXT, GET-RESPONSE 330-2, SET 330-1, and TRAP 330-3 to communicate between the manager 310 and the agent 320. For instance, when the manager wants to know the value of an MIB object, such as get an overload threshold of a PDU, or get an agent IP address, the manager will assemble a GET packet 330-2 that includes

$$[ [ getoverloadthreshold = {}^{``} PowerNet \text{-} MIB :: rPDULoadPhaseConfigOverloadThreshold . {phase}^{″} = 1.3 .6 .1 .4 .1 .318 .1 .1 .12 .2 .2 .1 .1 .4 ] ]$$

$$or \\ [ [ getreceiverip = {}^{``} PowerNet \text{-} MIB :: receiverAddr {.}^{″} = 1.3 .6 .1 .4 .1 .318 .2 .1 .2 .1 .2 ] ]$$

to the agent 320. Upon receiving the GET packet, the agent 320 will assemble and send a GET-RESPONSE packet to the manager 310 with either the current value of the MIB object or an error indication (TRAP) as to why the request cannot be processed. Similarly, the manager 310 will assemble a SET packet that includes the OID for each MIB object of interest, thereby requesting a change be made to the value of the MIB object. The agent 320 will then respond with a SET-RESPONSE packet indicating the change has been made or an error (TRAP) indication as to why the change cannot be made. The agent 320 can also assemble and send a TRAP packet that includes OID and value information (bindings) to spontaneously inform the manager of an important event. The manager can use the bindings to correlate and manage the event.

Though the SNMP access is simple due to the small number of command messages (GET, GET-NEXT, GET-RESPONSE, SET, and TRAP), it requires that the user have in-depth knowledge of the MIB, and particularly be familiar with the OID of each MIB object. Also, building the variable binding which includes the OID and the corresponding object value is typically a tedious task and is subject to human errors. Additionally, various managed device products from various vendors have significant differences and these differences make the monitoring and managing these PDUs a difficult task.

The monitoring and management functions of the managed devices on the rack include one or more of following tasks: building a rack, adding devices to the rack, adding PDU to the rack, adding host server to PDU, adding BMC server to BMC rack, discovery of managed devices on the rack, rack power limit control, configuring power zone settings, scheduling power zone, scheduling rack power, configuring servers, configuring trap receivers, configuring managed devices on the rack, configuring power delay, setting threshold, performing remote control actions, monitoring real-time rack power usage, setting rack power limits, monitoring inlet temperature, providing managed device summary, providing server summary, event log information, and email alerts.

In certain embodiments, the rack management module 160 is configured to construct, configure, maintain, monitor, and manage the operations of the managed devices on the rack 170-I (managed devices). The managed devices on the rack also includes power distribution unit (PDU). The operations include: establishing a rack, configuring the rack, loading MIB files and INI files of managed devices on the rack, discovering managed devices on the rack, customizing the management of discovered managed devices on the rack, monitoring and managing these managed devices on the rack. The Rack management module 160 performs following functions:
interacting with the user interface module 130 to receive rack management information of the managed devices on the rack;
interacting with the file loader 120 to retrieve and store the rack management information of the managed devices on the rack to the database 110;
interacting with the rack management communication interface 150 to communicate with the managed devices on the rack over the communication link 190;
interacting with device discovery module 140 over the rack management communication interface 150 to discover all connected managed devices on the rack; and
monitoring and managing the operations of the managed devices on the rack.

The managed devices on the rack including PDUs are diverse products. For example, PDUs include basic PDUs, metered PDUs, switched PDUs, switched Per Outlet Power Sensing (POPS), smart PDUs and intelligent PDUs. Like PDUs, many managed devices on the rack come from various vendors and each product has specific functionalities different from other managed devices on the rack from the same or different manufacturers. These differences are reflected in the differences in the management information base (MIB) and associated management functions available for various managed devices from different vendors. For example, the switched POPS has power metering for each power outlet. Metered PDUs may have one power metering per PDU, and basic PDUs may have no power metering functions at all. On the other hand, some management functions such as the current storage space usage is a crucial performance measurement of the managed devices such as storage devices. For a computer server, the CPU and memory usages may be important performance measures. For a managed network device such as a router, the network bandwidth and speed are also very important performance measures. Therefore, the MIBs associated with different managed devices on the rack including PDU, computer servers, storage and network devices are significantly different from each other, and so are the management functions to be performed on these managed devices on the rack.

As mentioned above, simple network management protocol (SNMP) is one of tools used for managing computer servers, storage and network devices. The SNMP usually includes two primary elements: a manager and agents. The SNMP manager is management platform through which the administrator performs rack management functions. The SNMP agents are entities that interface to the actual managed devices. Computer servers, storage and network devices, and PDUs with network manageability are examples of managed devices that contain managed objects. The managed objects of each managed device might be hardware, configuration parameters, performance statistics, and so on, that directly relate to the current operation of the managed device. The managed objects are arranged in a management information base (MIB) and each managed object is referred to as an MIB object in the MIB. The SNMP allows managers and agents to communicate for the purpose of accessing these MIB objects.

In order for a management software to monitor and manage the PDU power supply to the racks, the OIDs of various products used in the rack needs to be entered into the MIB to customize the management of particular products used. Since the managed devices are a part of one or more racks, at least one rack has to be established and configured before any managed devices are to be managed. Therefore, the rack management includes two steps: (1) establish and configure a rack, and (2) configure managed devices discovered on the rack.

Conventionally, an operator is required to enter the detailed information for each managed device installed in the rack through the user interface module 130 of the rack management system 100 to set up the MIB line by line. Each product may require the operator to enter up to 50-60 parameters and there may be hundreds of products need to be entered.

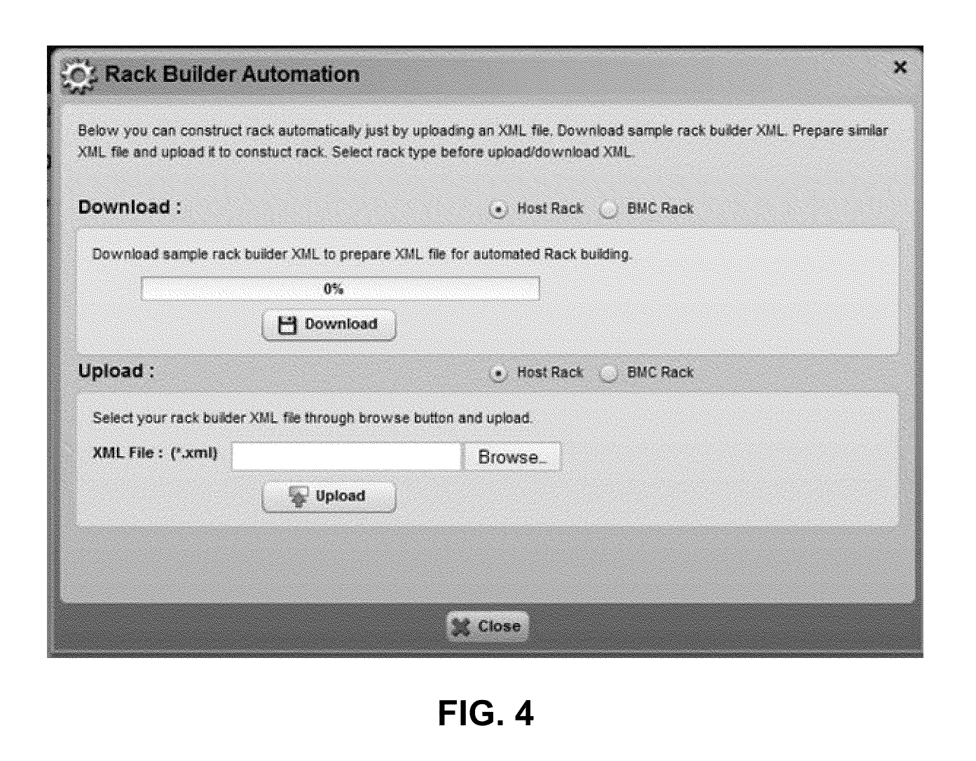

FIG. 4 shows an exemplary rack building screen according to one embodiment of the present disclosure. Rack automation is a feature provided to construct a rack. For that, a user will need to create an XML file, which will contain information regarding rack name and their respective devices details.

<?xml version=“1.0” encoding=“UTF-8”?>
<racklist>
<rack name= “HOSTRack” powerlimit=“1000” type=“host”>

<node>

<name>PDU-1</name>
<ipaddress>10.10.1.1</ipaddress>
<ratedpower>200</ratedpower>
<powerzone>Critical</powerzone>
<inlettemp>22</inlettemp>

</node>
<node>

<name>Web-server1</name>
<ipaddress>10.10.1.2</ipaddress>
<ratedpower>200</ratedpower>
<powerzone>Critical</powerzone>
<inlettemp>22</inlettemp>

</node>

</rack>
</racklist>

Following are the steps to construct a Rack automatically as shown in FIG. 4:
(a) the user selects Host Rack from the radio button for downloading the XML file for the selected rack type.
(b) the user clicks Download button to download the sample XML file in the required location for building the rack automatically.
(c) the user selects Host Rack from the radio button for uploading the XML file for the selected rack type.
(d) the user clicks Browse button to open the sample XML file.
(e) the user clicks Upload button to view the result of the operation.
(f) the user clicks OK button to build the rack automatically and is displayed under Power Management Devices in the device tree.

The user can edit a sample XML file for adding or editing the following details. This helps the user to create a rack automatically according to their needs.
rack name
rack power limit
rack type
PDU name
PDU IP address
Host server name
Host server IP address
Rated power
Power zone
Outlet id

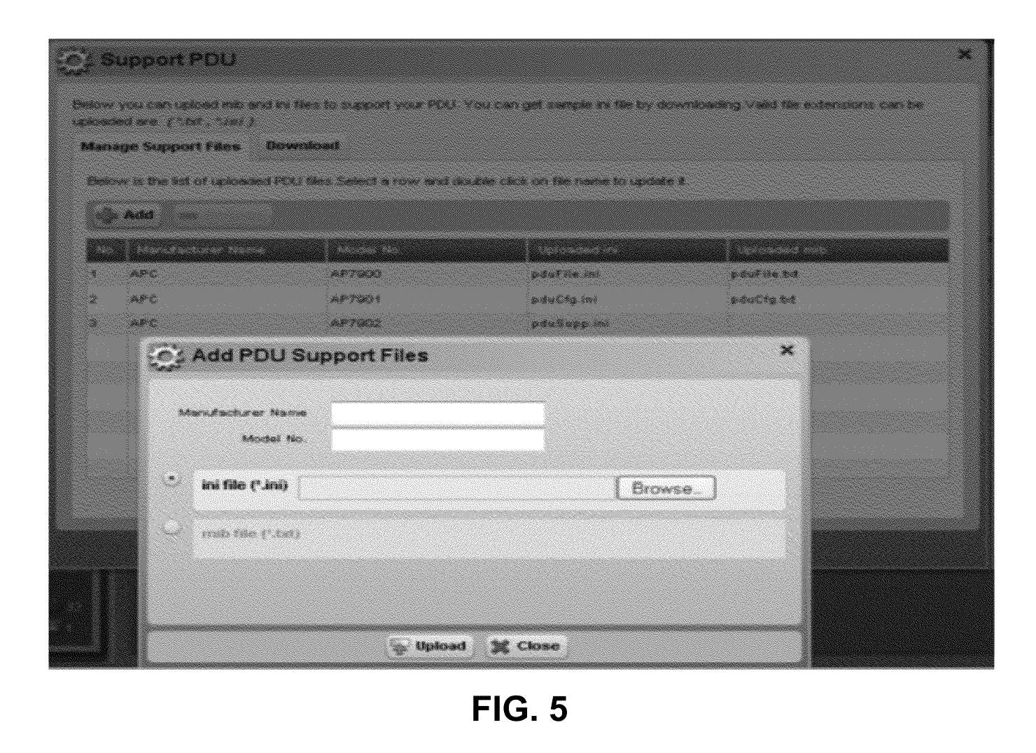

FIG. 5 shows an exemplary user interface screen for provide dynamic PDU support according to one embodiment of the present disclosure. Following are the steps to provide dynamic PDU support:
(a) the user enters the PDU manufacture name and mode number, upload the MIB, and INI files.
(b) the uploaded MIB and INI files, the manufacturer name, model number and file name are stored at a predetermined location of the database 110.
(c) the device discovery module 140 receives the rack management information of the managed devices on the rack such as the MIB files and INI files through the file loader 120, and based on a pre-determined IP address range, the device discovery module 140 of the rack management system 100 discovers connected and managed devices on the rack 170-I, I=1, 2, . . . , N through the rack management communication interface 150 and the communication link 180. Before the device discovery module 140 loads MIB and INI files, the user interface 130 will check for existence of same details in rack management system 100.
(d) Once all the managed devices on the rack are discovered, the rack management module 160 will map a subset of basic management functions of the managed device from the MIB of the managed devices on the rack, and store the mapped subset of basic management functions in the database 110 for the rack management system 100.
(e) the rack management system 100 is ready to perform the mapped subset of basic management functions of the managed devices on the rack in the database 110.

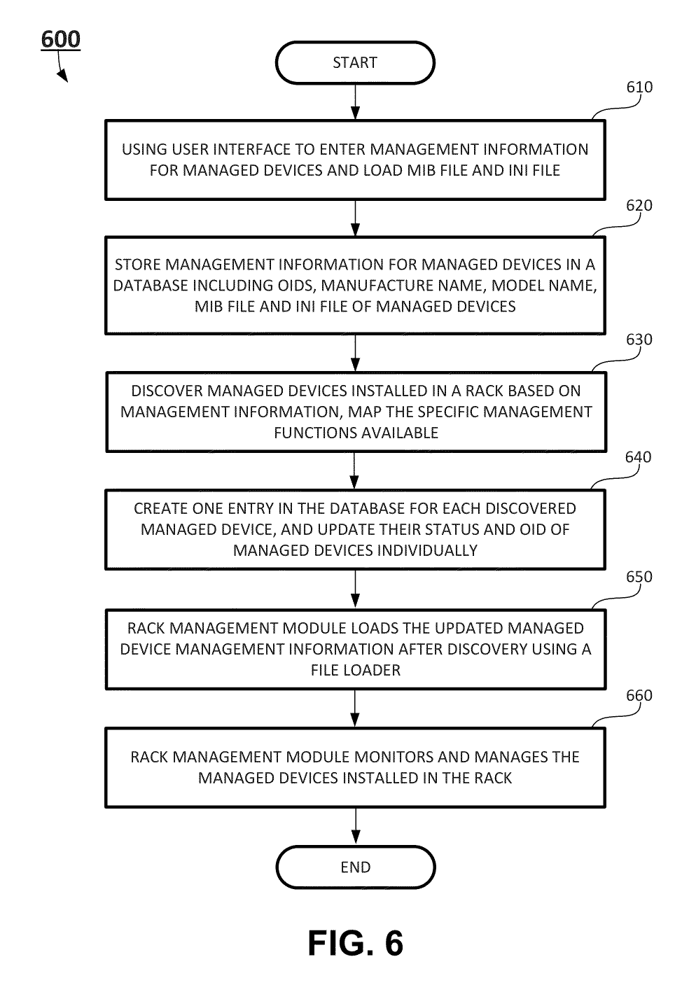

Referring now to FIG. 6, a flow chart 600 of operation of the rack management system 100 for constructing, configuring, monitoring and managing various managed devices on the rack is shown according to one embodiment of the present disclosure. In one embodiment, the managed devices on the rack can be any type of device, including, but not limited to, routers, access servers, switches, bridges, hubs, IP telephones, IP video cameras, computer hosts, and printers.

At the STEP 610, an administrator enters rack management information such as manufacturer names, model numbers, their IP addresses, device names, and uploads related MIB files and INI files associated with the managed devices on the rack through the user interface module 130. The INI files provides the rack management module 160 a standard rack management functionality set, which is a subset of the management functions available to the managed devices from manufacturers. The rack management module 160 parses the MIB file and map the OID and the standard management functionality set. The parsing of the MIB file and mapping of the standard management functions can be carried out either manually or automatically through the user interface module 130 and rack management module 160.

At the STEP 620, the rack management module 160 saves all rack management information including manufacturer names, the model numbers, the IP addresses, the device names, the MIB file, selected OIDs, and the standard management functionality set of the managed device into the database 110 through the file loader 120.

At the STEP 630, the device discovery module 140 discovers the connected/installed managed devices on the rack one by one based on their IP addresses and matches the specific management functions available to the managed devices on the rack. The device discovery module 140 of the rack management system 100 retrieves the rack management information of the managed devices on the rack from database 110 through the file loader 120, and discovers the managed devices on the rack one by one;

At the STEP 640, the rack management module 160 create one entry in the database 110 for each discovered managed device for management, and update the managed device status and OIDs of the discovered managed devices on the rack individually;

At the STEP 650, the rack management module 160 loads updated the rack management information of the managed devices on the rack, OID information and INI files for the discovered managed devices on the rack using the file loader 120 from the database 110.

At the STEP 660, the rack management module 160 of the rack management system 100 monitors and manages the discovered managed devices on the rack based on the management functions, the related OID, the current status of the managed devices on the rack.

A data center is a facility used to house computer systems and associated components, such as telecommunications and storage systems. It generally includes redundant or backup power supplies, redundant data communications connections, environmental controls (e.g., air conditioning, fire suppression) and security devices. IT operations are a crucial aspect of most organizational operations around the world. One of the main concerns is business continuity. Companies rely on their information systems to run their operations. If a system becomes unavailable, company operations may be impaired or stopped completely. It is necessary to provide a reliable infrastructure for IT operations, in order to minimize any chance of disruption. Typically, a data center includes many different kinds of electronic devices, including routers, access servers, switches, bridges, hubs, IP telephones, IP video cameras, computer hosts, and printers. Most of these devices are mounted on racks. Therefore, rack management systems provide solutions to ensure highly secure, fault tolerant operations of such data centers. The rack management system provides the capability to monitor data from the real world environment. The monitored data includes: Power, temperature, humidity from intelligent power strips, PDUs, or Building Management Systems (BMS), Any real time or variable value network accessible attribute, Via SNMP Gets or connect directly to other systems for data acquisition through a WSDL API, Server CPU, disk activity, and memory usage. Due to the fact that there are so many data points to monitor, the configuration of these racks in a rack management system is rather tedious and repetitive, and difficult to manage. It is desirable to have a mechanism to be able to export the configuration of certain racks after the configurations of these racks are completed such that the configurations of these racks can be used as references for configuring other similar racks.

Although these devices are diverse, it is also a common practice that a data center contains many racks of similar devices. For example, data centers housing large web search engines such as GOOGLE or YAHOO may include a large amount of racks mounted with similar computer servers, and similar storage devices. The devices on these racks are operated in parallel. In addition, in a data center with redundant equipment, there is at least one pair of identical racks for each independent rack, one is in operation and the other is a backup. The configuration similarity among the racks can be used to simplify the configuration of similar racks having similar type of devices and configurations. Therefore, it is also desirable to be able to “clone” the configuration of rack management information of many same or similar racks from a model rack to avoid user error, and save configuration time.

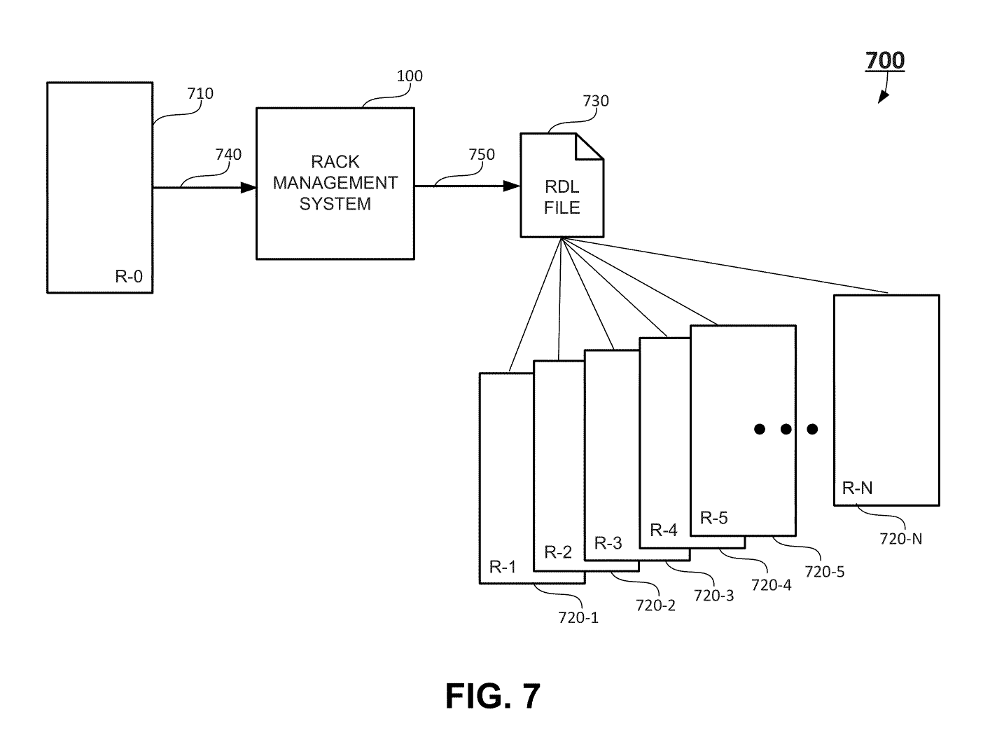

FIG. 7 shows an exemplary importing rack management information from a model rack and exporting imported rack management information to a group of racks having similar managed devices and configuration in a data center according to one embodiment of the present disclosure. In certain embodiments, the rack management information of a model rack R-0 710 is imported by the rack management system 100, as indicated by the import action 740, from the model rack R-0 710 after the model rack R-0 710 has completed its configuration. The rack management information includes RackInfo, and NodeInfo as described earlier. The RackInfo and NodeInfo are exported (i.e. extracted and stored in the database of the rack management system 100) from the model rack R-0 710. The rack management information can be stored in text files, excel files, XML files or rack definition language (RDL) files. There are N target racks R-I, 720-I, I=1, 2, . . . , N. For simplicity, it is assumed that these racks 720-1 through 720-N have same number of managed devices installed on the rack, and same system configurations as the model rack R-0 710.

Once the rack management information of the model rack R-0 710 is imported into the rack management system 100, and is stored in the database of the rack management system 100. In this example, the rack management information of the model rack R-0 710 is stored in the database of the rack management system 100. A user of the rack management system 100 can use the rack management system to edit, modify the rack management information when it is needed. For example, if a target rack R-1 720-1 is not identical to the model rack R-0 710, and is slightly different, the user can edit the rack management information to make minor changes, such as add a managed device, to remove a managed device, to modify the IP addresses of the managed devices on the rack, to change the name and model number of the managed devices etc. Once the rack management information is edited and stored in the database, the rack management information can be exported to a RDL file 730 and the RDL file 730 can be used to configure the target racks R-1 through R-N.

When the user of the rack management system 100 wants to configure the target racks R-1 through R-N, he/she uses the RDL file 730 to export the rack management information to the target racks R-1 through R-N individually. Each managed devices on the target rack is configured, discovered by the device discovery module, and the status of the managed devices on the target rack is updated and stored in the database of the rack management system. Once a target rack is completed configured, this target rack can also be used as a model rack, and the rack management information for this rack can also be imported to become the rack management information of a new model rack.

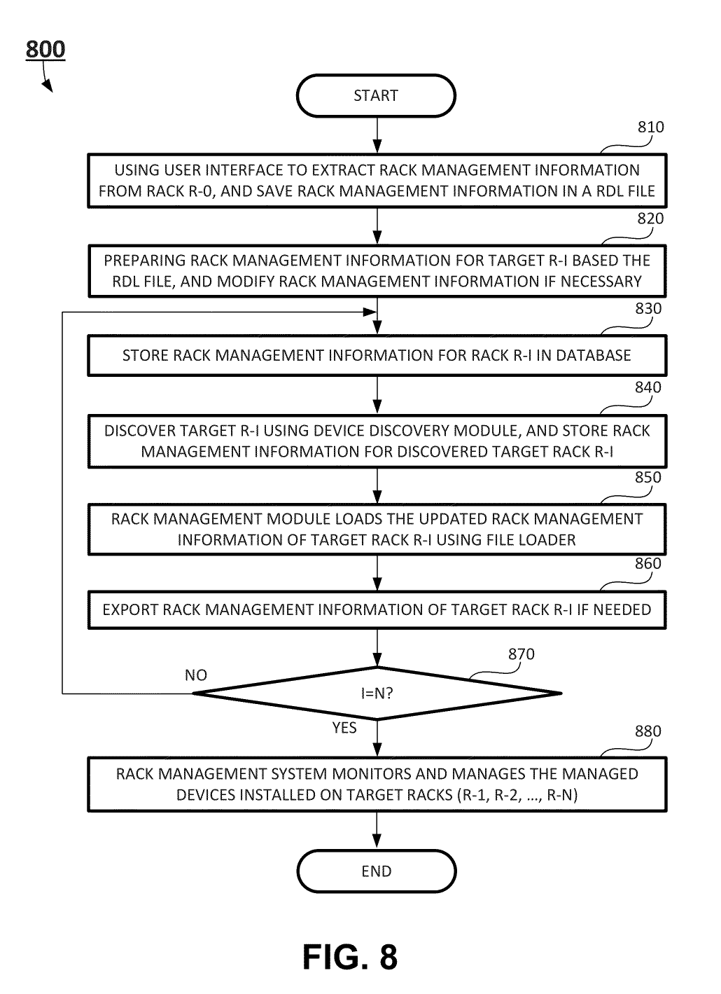

FIG. 8 shows a flow chart of operation of the rack management system for importing rack management information from a model rack and exporting imported rack management information to a group of racks having similar managed devices and configuration according to one embodiment of the present disclosure.

At the STEP 810, First, the user of the rack management system 100 set the rack counter I=0, and imports the rack management information of a model rack R-0 by using the user interface module of the rack management system. The importation of the rack management information for the model rack R-0 include: (a) extracting the rack management information from the model rack R-0, (b) store the rack management information from the model rack R-0 into the database of the rack management system, and (c) export the rack management information of the model rack R-0 into a RDL file 730 as shown in FIG. 7. The rack management information for the model rack R-0 includes: the RackInfo of the model rack R-0, the NodeInfo of the model rack R-0, the MIB files and the INI files of all managed devices on the model rack R-0, and all related OIDs of the objects on the model rack R-0.

At the STEP 820, the user exports the rack management information of the model rack R-0 as the rack information of target rack R-I. The export of the rack management information includes: (a) copying the rack management information of model rack R-0 using the file loader based on the RDL file 730, (b) storing the copied rack management information of model rack R-0 into the rack management information of the target rack R-I, (c) save rack management information of the target rack R-I into the database, and (c) making minor modifications to the RDL file 730 if necessary.

At the STEP 830, The rack counter is increase by 1 (I=I+1), and the user stores the rack management information of the target rack R-I in the database of the rack management system. The rack management information for the target rack R-I includes: the RackInfo of the rack R-I, the NodeInfo of the rack R-I, the MIB files, the INI files, and all related OIDs of the objects on the model rack R-0. The rack management information for the target rack R-I may be the same as the rack management information for the model rack R-0 if the configurations of these two racks R-I and R-0 are the same except the IP addresses of the managed devices installed on the target rack R-I, or slightly different if the configurations of these two racks R-I and R-0 are slightly different after the modifications made in STEP 820.

At the STEP 840, the device discovery module of the rack management system uses the rack management information of the R-I to discover target rack R-I management information of the target rack R-I in the database of the rack management system.

At the STEP 850, the rack management module of the rack management system loads the updated rack management information for the target rack R-I, and updates the status of all managed devices on the target rack R-I.

At the STEP 860, the rack management information of the target rack R-I can be exported to another RDL file if necessary.

At the STEP 870, the rack management module of the rack management system checks if the last target rack R-N is configured. If yes, the configuration process of the target racks R-1 through R-N is completed, and proceeds to the STEP 880. Otherwise, the configuration proceeds to STEP 830, where the rack counter I is increased by 1 so that the next rack is configured.

At the STEP 880, the rack management system completes the configuration of the target racks R-1 through R-N, and manages and monitors the managed devices on the target rack R-1 through R-N.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A rack management system for automatically construct a rack, configure, monitor and manage a plurality of managed devices on the rack comprising:
a user interface module configured to allow an administrator to enter or import rack management information of the plurality of managed devices on the rack;
a database configured to store the rack management information of the plurality of the managed devices on the rack;
a rack management communication interface configured to facilitate the communication between the rack management system and the plurality of managed devices on the rack through a communication link;
a rack management module configured to construct, configure, monitor, and manage the plurality of the managed devices;
a device discovery module configured to discover all managed devices according to the information entered by the administrator through the user interface module; and
a file loader configured to load the rack management information of the plurality of managed devices on the rack to the database, the device discovery module and the rack management module.

2. The rack management system of claim 1, wherein the plurality of managed devices on the rack comprises one or more of:
power distribution unit (PDU);
computer servers;
storage devices;
access servers;
switches;
bridges;
hubs;
IP telephones;
IP video cameras;
computer hosts;
network devices; and
printers.

3. The rack management system of claim 1, wherein the rack management information comprises the management information of each of the plurality of managed devices on the rack including name of the manufacturer, model number, IP address, Device name, management information base (MIB) file, and a standard set of management functions described in an INI file.

4. The rack management system of claim 1, wherein the rack management information of the plurality of managed devices on the rack is entered manually through the user interface module, or automatically imported from a set of pre-edited files, wherein the set of pre-edited files comprises the rack management information exported from a rack that contains similar managed devices and similar configuration as the plurality of managed devices on the rack.

5. The rack management system of claim 4, wherein the set of pre-edited files comprises at least a management information base (MIB) file containing all management functions and its related object identification (OID), an INI file containing a standard set of management functions of the rack management system, and a rack definition file containing rack configuration information using a rack definition language, wherein the rack management module parses the MIB file, maps the standard set of rack management functions of the plurality of managed devices on the rack, and obtains the object identification (OID) associated with the standard set of management functions of the plurality of managed devices on the rack.

6. The rack management system of claim 5, wherein the rack definition file comprises a text file, an excel file, and an XML file.

7. The rack management system of claim 5, wherein the standard set of management functions of the rack management system in the INI file comprises a subset of the management functions available to the managed device from its manufacturer.

8. The rack management system of claim 1, wherein the device discovery module is configured to
load the rack management information of the plurality of managed devices on the rack through the file loader from the database;
discover the plurality of managed devices on the rack through the rack management communication interface and the communication link based on the rack management information of the plurality of managed devices on the rack including their IP addresses; and
create one entry in the database for each discovered managed device for individual management of the discovered managed device.

9. The rack management system of claim 1, wherein the rack management module uses simple network management protocol (SNMP) to monitor and manage the plurality of managed devices on the rack.

10. The rack management system of claim 9, wherein the rack management module further comprises:
a web interface to allow the administrator to perform management functions remotely through internet, LAN, WAN, and Wi-Fi networks; and
a command line interface (CLI) to allow the administrator to perform management functions locally through a RS-232 network.

11. A method for a rack management system to construct a rack, configure, monitor and manage a plurality of managed devices on the rack comprising one or more of:
entering rack management information of the plurality of managed devices on the rack by an administrator using a user interface module of the rack management system, or importing a set of pre-edited files exported from a rack that has similar managed devices and configuration;
storing the rack management information of the plurality of managed devices on the rack into a database of the rack management system using a file loader of the rack management system;
loading rack management information of the plurality of managed devices on the rack through the file loader to a device discovery module;
discovering the plurality of managed devices on the rack one by one based on the rack management information of the plurality of managed devices on the rack;
creating one entry in the database for each discovered managed device for rack management;
exporting rack management information of the plurality of managed devices on the rack;
updating the managed device status and OID of the discovered managed device in the database individually;
loading the OID information and a set of pre-determined rack management functions through the file loader to the rack management module; and
monitoring and managing the plurality of managed devices on the rack through the rack management module.

12. The method of claim 11, wherein the plurality of managed devices on the rack comprises one or more of:
power distribution unit (PDU);
computer servers;
storage devices;
access servers;
switches;
bridges;
hubs;
IP telephones;
IP video cameras;
computer hosts;
network devices; and
printers.

13. The method of claim 11, wherein the set of pre-edited files comprises at least a management information base (MIB) file containing all management functions and its related object identification (OID), an INI file containing a standard set of management functions of the rack management system, and a rack definition file containing rack configuration information using a rack definition language, wherein the rack management module parses the MIB file, maps the standard set of rack management functions of the plurality of managed devices on the rack, and obtains the object identification (OID) associated with the standard set of management functions of the plurality of managed devices on the rack.

14. The method of claim 13, wherein the parsing of the MIB file and mapping of the standard management functions are carried out:
manually by using a user interface module, and
automatically by using the user interface module.

15. The method of claim 13, wherein the rack definition file comprises a text file, an excel file, and an XML file.

16. The method of claim 13, wherein the standard set of management functions of the rack management system in the INI file comprises a subset of the management functions available to the managed device from its manufacturer.

17. The method of claim 11, wherein the rack management system further comprises a rack management communication interface configured for the rack management system to communicate with the plurality of managed devices on the rack through a communication link.

18. The method of claim 11, wherein the rack management module uses simple network management protocol (SNMP) to monitor and manage the plurality of managed devices on the rack.

19. The method of claim 11, wherein the rack management module further comprises
a web interface to allow the administrator to perform management functions remotely through internet, LAN, WAN, and Wi-Fi networks.
a command line interface (CLI) to allow the administrator to perform management functions locally through a RS-232 network.

20. A method for a rack management system to construct a plurality of target racks based on rack management information of a model rack, comprising one or more of:
importing rack management information from the model rack;
storing the imported rack management information of the model rack in a rack definition language (RDL) file;
exporting the rack management information of the model rack in the RDL file to rack management information of a target rack;
storing the rack management information of the target rack into a database of the rack management system;
discovering managed devices on the target rack using a device discovery module of the rack management system;
updating the status of the managed devices on the target rack; and
exporting updated rack management information of the target rack if necessary.

21. The method of claim 20, wherein the plurality of managed devices on the rack comprises one or more of:
power distribution unit (PDU);
computer servers;
storage devices;
access servers;
switches;
bridges;
hubs;
IP telephones;
IP video cameras;
computer hosts;
network devices; and
printers.

22. The method of claim 20, wherein the rack management system comprises RackInfo of the rack, NodeInfo of the rack, MIB files and INI files of all managed devices on the rack, and all related OIDs of objects on the rack.

23. The method of claim 22, wherein the rack management system comprises a user interface module configured to allow an administrator to enter or import rack management information of the plurality of managed devices on the rack.

24. The method of claim 23, wherein the rack management information is entered manually through the user interface module, or automatically imported from a set of pre-edited files, wherein the set of pre-edited files comprises the rack management information exported from the model rack that contains similar managed devices and similar configuration as the plurality of managed devices on the rack.

25. The method of claim 24, wherein the set of pre-edited files comprise one or more of a text file, an excel file, and an XML file.
